(19) United States
(12) Patent Application Publication
(10) Pub. No.: US 2002/0066078 A1
(43) Pub. Date: May 30, 2002

(54) Apparatus, method, and program for designing real-time system

(75) Inventors: Masaki Ishii, Yokohama-shi (JP); Hisaki Makida, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Minato-ku (JP)

(21) Appl. No.: 09/924,489

(22) Filed: Aug. 9, 2001

(30) Foreign Application Priority Data
Aug. 9, 2000 (JP) P2000-241688

(51) Int. Cl. G06F 9/44

(52) U.S. Cl. 717/126; 717/124

(57) ABSTRACT

A real-time system designing apparatus helps easily forming a real-time system and shortening the development period of applications to be designed based on the real-time system.

The apparatus has a user inter face for receiving data entered by a user and displaying extracted parameters, etc., for the user, a parameter extractor for extracting parameters representing the start and end states of each sub-scenario, a state memory for storing the extracted parameters, a connector-tester for connecting sub-scenarios together and testing the consistency of the connected sub-scenarios, and a connection memory for storing sub-scenario connection data.

### CROSS-REFERENCE TO RELATED APPLICATIONS

This application is based upon and claims the benefit of priority from the prior Japanese Patent Application No. 2000-241688, filed on Aug. 9, 2000; the entire contents of which are incorporated herein by reference.

### BACKGROUND OF THE INVENTION

1. Field of the Invention

The present invention relates to an apparatus for designing a real-time system, a method of designing a real-time system, and a program for making a computer execute the real-time system designing method. In particular, the present invention relates to a technique of designing a real-time system by controlling the behavioral consistency of the system and by describing parallel operations of the system in time series.

2. Description of the Related Art

When forming a real-time system for concurrently processing a plurality of tasks, it is difficult to realize system behavioral consistency and synchronous task-to-task communication because spontaneous interrupts and periodic time-out processes asynchronously bother the tasks. As the scale of a real-time system to design increases, it becomes more difficult to include such interrupts and time-out processes in the designing of the system.

To simplify the designing of a real-time system, there are techniques of describing task operations in time series.

The behavior of each task is affected by asynchronous factors such as interrupts as mentioned above, and therefore, it is difficult for general real-time systems to define a total system behavior from a single time series of data.

Forming a real-time system and developing applications based on the real-time system, therefore, needs a long time.

### BRIEF SUMMARY OF THE INVENTION

An apparatus for designing a real-time system involving a plurality of tasks according to an embodiment of the present invention comprises an asynchronous factor tester for testing whether or not task operations arranged in time series in a given section are affected by asynchronously occurring factors.

The “task operations arranged in time series in a given section” are a series of task operations such as 1) a task A updating a task B from dormant state to ready state, 2) the task A updating a task C from dormant state to ready state, and 3) the task A updating the task A itself from ready state to dormant state.

The “asynchronous factors” include interrupt and time-out processes. If an interrupt, which is an asynchronous factor, causes no branching, it is determined that the interrupt has no influence on task operations.

### BRIEF DESCRIPTION OF THE SEVERAL VIEWS OF THE DRAWINGS

FIG. 1 shows an example of a scenario to define the behavior of a real-time system;

FIG. 2 shows a plurality of scenarios combined to define the behavior of a real-time system;

FIG. 3 shows an example of a sub-scenario having parameters to determine the sub-scenario's connectivity;

FIG. 4 is a functional block diagram generally showing an apparatus for designing a real-time system according to an embodiment of the present invention;

FIG. 5 is a flowchart showing the operation of a parameter extractor 12 contained in the apparatus of FIG. 4;

FIG. 6 is a flowchart showing “(b) Initial state determination” of FIG. 5;

FIG. 7 is a flowchart showing “(c) Operation registration” of FIG. 5;

FIG. 8 is a flowchart showing “(d) Data extraction” of FIG. 5;

FIG. 9 is a flowchart showing “(e) State extraction” of FIG. 5;

FIG. 10 is a flowchart showing “(f) Consistency test” of FIG. 5;

FIG. 11 is a flowchart showing the operation of a connector-tester 13 contained in the apparatus of FIG. 4;

FIG. 12 shows a sub-scenario 1 to define a task S activating tasks A and B;

FIG. 13 shows a sub-scenario 2 to define the task B determining whether an evaluation result is valid or invalid;

FIG. 14 shows a sub-scenario 3 to define the task B accessing an OS resource;

FIG. 15 shows a sub-scenario 4 to define the task A operating asynchronously;

FIG. 16 shows a sub-scenario 5 to define a resource or data asynchronously accessed by the task A;

FIG. 17 roughly shows a real-time system constructed by connecting the sub-scenarios 1 to 5; and

FIG. 18 shows an example of a computer system used to execute the real-time system designing method of the present invention.

### DETAILED DESCRIPTION OF THE INVENTION

Embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following explanation, a user designs a real-time system based on a real-time OS. The present invention expresses the time-series behavior of a real-time system with “scenarios.” The present invention prepares sub-scenarios each representing a limited section of a real-time system and connects the sub-scenarios without inconsistency, to define the behavior of the real-time system. In this embodiment, the real-time OS is μITRON 3.0, or any other real-time OS whose specifications are similar to those of μITRON 3.0. The definitions of technical terms to describe a real-time system in the following explanation are based on the specifications of μITRON 3.0.

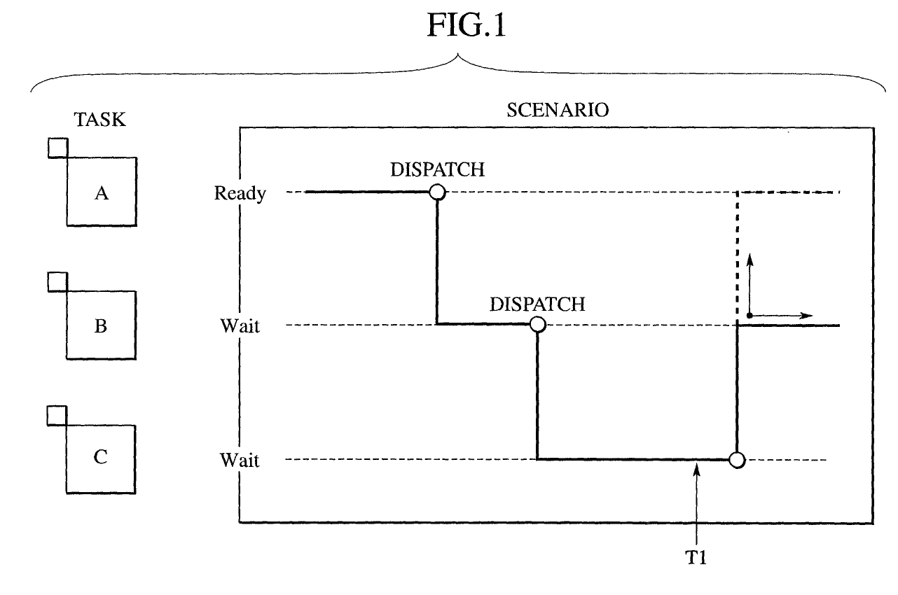

FIG. 1 shows an example of a scenario defining the behavior of a real-time system according to an embodiment of the present invention. The scenario defines the behavior of the real-time system in time series.

The scenario shows, in time series, the possible states and interactions of tasks involved in the real-time system.

Generally, the operating conditions of a real-time system are changed by, for example, interrupts, and therefore, it is impossible to define the total behavior of the real-time system with a single scenario. For example, an interrupt occurring at T1 may transfer control to a task A instead of a task B. This type of behavior is unable to define with a single scenario.

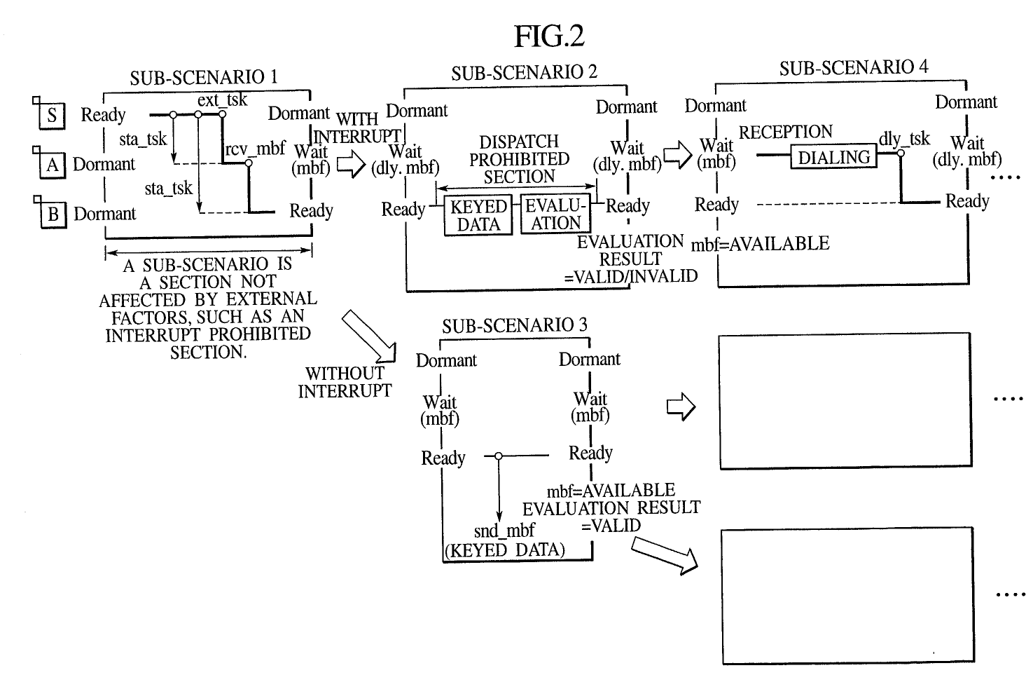

To cope with this problem, the present invention enables a system developer or a user to define short scenarios that describe the behavior of tasks at various locations in a real-time system. The short scenarios are connected to one another as shown in FIG. 2, to define the total behavior of the real-time system. The short scenarios are called “sub-scenarios” in this specification.

Each sub-scenario corresponds to a section in a general scenario describing a real-time system. In each sub-scenario, each task operation is free from the influence of external factors. Within a sub-scenario, no branching occurs even if an asynchronous event such as an interrupt occurs.

Each sub-scenario is extendable as long as the scenario defining rules mentioned above are kept. A sub-scenario may be divided into two if the definition of a real-time system to design allows it, so that the latter half of the divided sub-scenarios may be used as a loop starting point.

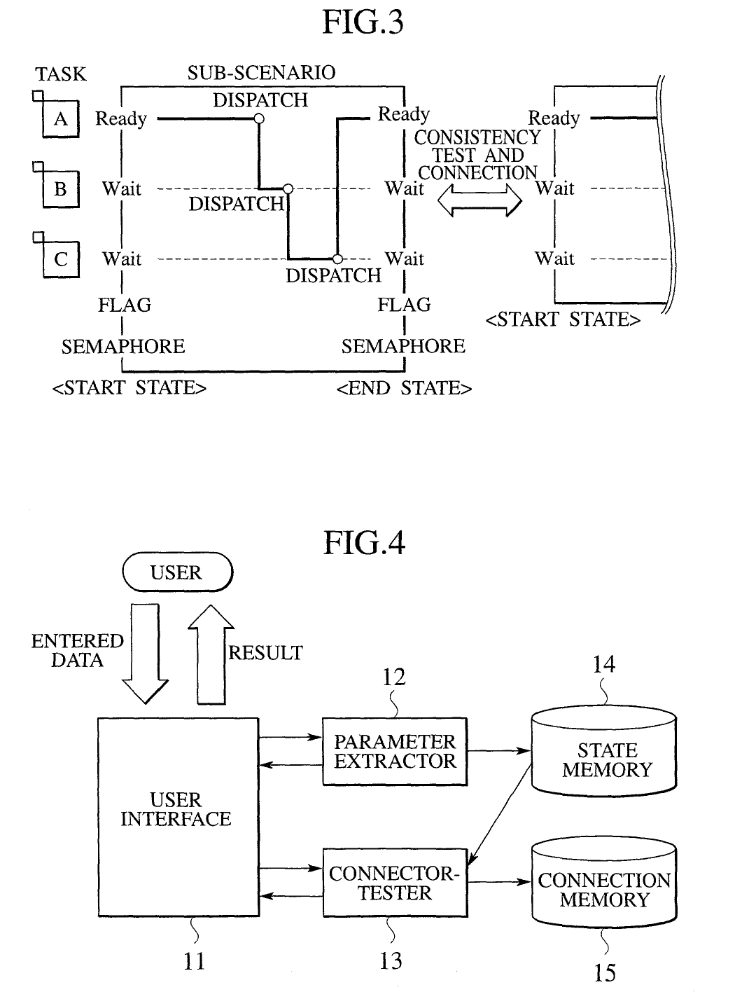

FIG. 3 shows an example of a sub-scenario having parameters to determine the connectivity of the sub-scenario.

In FIG. 3, the sub-scenario is defined with (1) start task states such as ready and wait states, (2) end task states, and (3) real-time OS resources such as flags and semaphores or global variables to be accessed in the sub-scenario. The embodiment of the present invention includes a mechanism of extracting sub-scenario parameters corresponding to task states from every sub-scenario.

The embodiment of the present invention also includes a mechanism of combining sub-scenarios into a real-time system by collating the end state parameters of a given sub-scenario with the start state parameters of a sub-scenario to be connected to the given sub-scenario, to test if the real-time system operates consistently.

Due to these mechanisms, each sub-scenario according to the embodiment of the present invention is free from the influence of asynchronous factors that may change real-time OS resources and global variables. The sub-scenarios are used in combination to define branching processes to handle changes in the real-time OS resources and global variables, thereby securing the consistency of a real-time system to be designed.

FIG. 4 is a functional block diagram generally showing an apparatus for designing a real-time system according to an embodiment of the present invention. The apparatus at least includes a user interface 11, a parameter extractor 12, a connector-tester 13, a state memory 14, and a connection memory 15.

The user interface 11 receives data entered by a user. The entered data relates to tasks, real-time OS resources, global variables, and task operations defined in sub-scenarios. The task operations include, for example, issuing system calls and reading/writing the global variables. The user interface 11 also has a function of displaying user-defined sub-scenario parameters, task operations, sub-scenario state changes in time series as shown in FIG. 3.

The parameter extractor 12 receives sub-scenario start state parameters and task operation data from the user interface 11 and executes two functions. The two functions are (1) determining whether or not a sub-scenario with entered operations terminates and (2) extracting parameters from a defined sub-scenario. Results of the parameter extractor 12 are supplied to the user interface 11, which provides the results to the user. The parameters extracted by the parameter extractor 12 are written into the state memory 14.

The connector-tester 13 receives connection data for two sub-scenarios selected by the user from among sub-scenarios entered into the user interface 11. The connector-tester 13 executes two functions. One is carrying out a consistency test to see if the two sub-scenarios cause no system inconsistency when they are connected to each other. The other is testing a loop. When the end of a sub-scenario is connected to the start of a first one of the selected two sub-scenarios that contains asynchronous factors, to form a loop, the connector-tester 13 reads parameters of all sub-scenarios concerned from the state memory 14 and tests system operation consistency according to the read data. When an interrupt or time-out process is defined, the connector-tester 13 also carries out the two functions. A consistency test result from the connector-tester 13 is supplied to the user interface 11. Connection data for the two sub-scenarios is stored in the connection memory 15.

The state memory 14 has a function of storing start and end state parameters extracted by the parameter extractor 12 from sub-scenarios defined by the user.

The connection memory 15 has a function of storing the connection data of sub-scenarios provided by the connector-tester 13 and data related to sub-scenarios that involve asynchronous factors.

Forming an application based on a real-time OS and describing a real-time system involving the application with sub-scenarios according to an embodiment of the present invention will be explained. In the following explanation, the real-time OS is assumed to be the μITRON 3.0.

An outline of the application to be formed is as follows:

1) The application carries out a dialing operation for a telephone set.

2) The application receives data entered by a user with numeric keys and sends a dial pulse signal representing the received data to a telephone line.

The specifications of the application are as follows:

1) The telephone set has other keys in addition to the numeric keys. If a key other than the numeric keys is pressed during a dialing operation, the pressed key is ignored to take no action.

2) The dialing operation is carried out by software using pulse strings.

3) During the dialing operation, new keyed data is acceptable.

The structure of the real-time system is as follows:

Tasks involved in the real-time system are a task S of the first priority for a startup process, a task A of the second priority for dialing, and a task B of the third priority for receiving keyed data.

The real-time system involves only one OS resource, i.e., a message buffer (mbf).

Data used in the real-time system is numeric keyed data.

System calls based on μITRON 3.0 used by the embodiment include “sta_tsk,” “ext_tsk,” “snd_mbf,” “rcv_mbf,” and “dly_tsk.”

A system restriction employed by the embodiment is that one priority level involves only one task.

[Sub-scenario Definition]

<Setting Parameters Common to All Sub-scenarios>

The user first enters tasks to be included in the real-time system, the priority levels of the tasks, and resources into the user interface 11 of FIG. 4. The user specifies tasks that are ready at the start of the real-time system.

According to the embodiment, the user enters 1) the tasks S, A, and B, 2) the priority levels of the tasks S, A, and B, 3) a message buffer (mbf) as a resource, and 4) the task S as a task that is ready at the start of the real-time system. These data pieces are transferred from the user interface 11 to the parameter extractor 12.

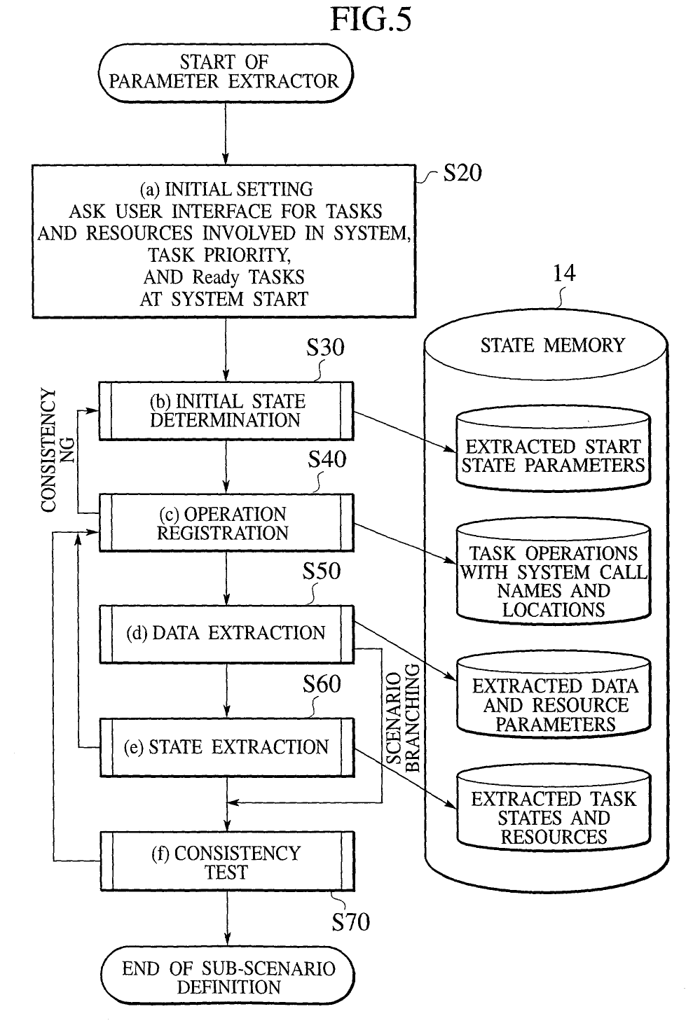

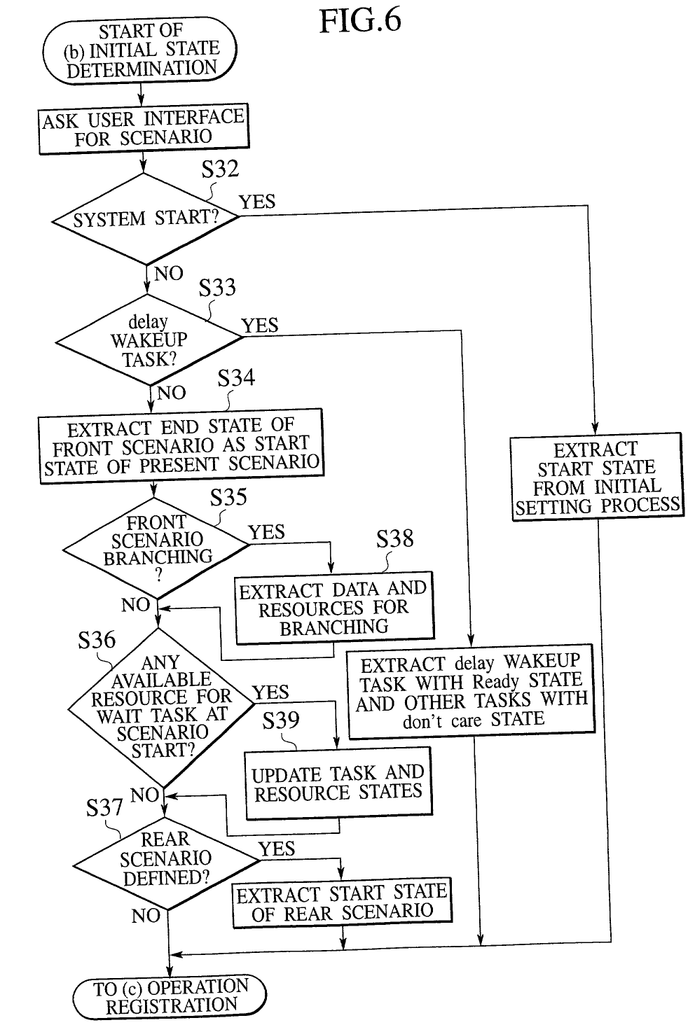

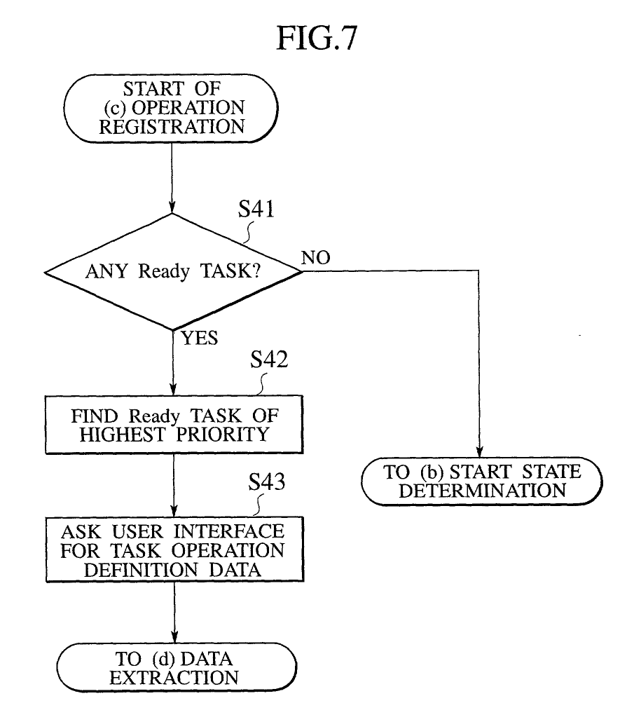

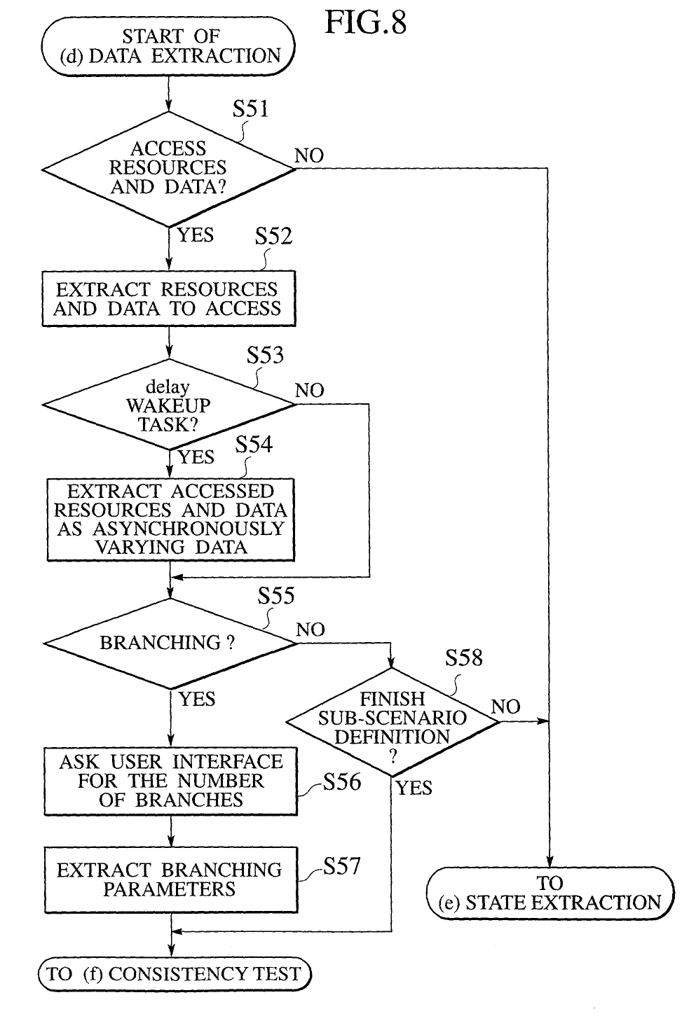

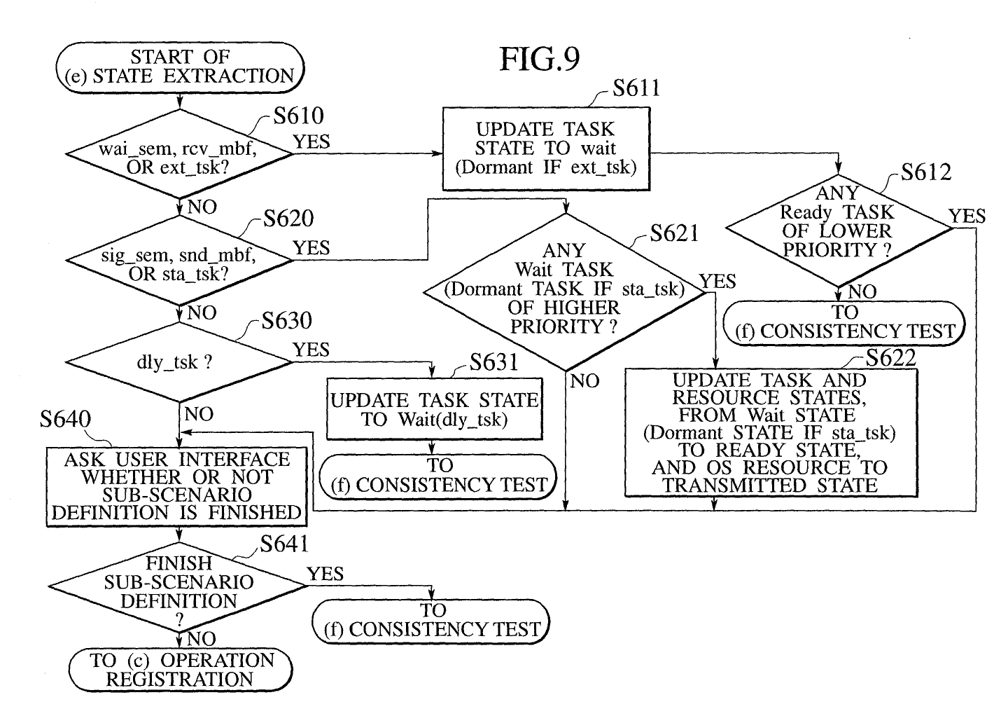

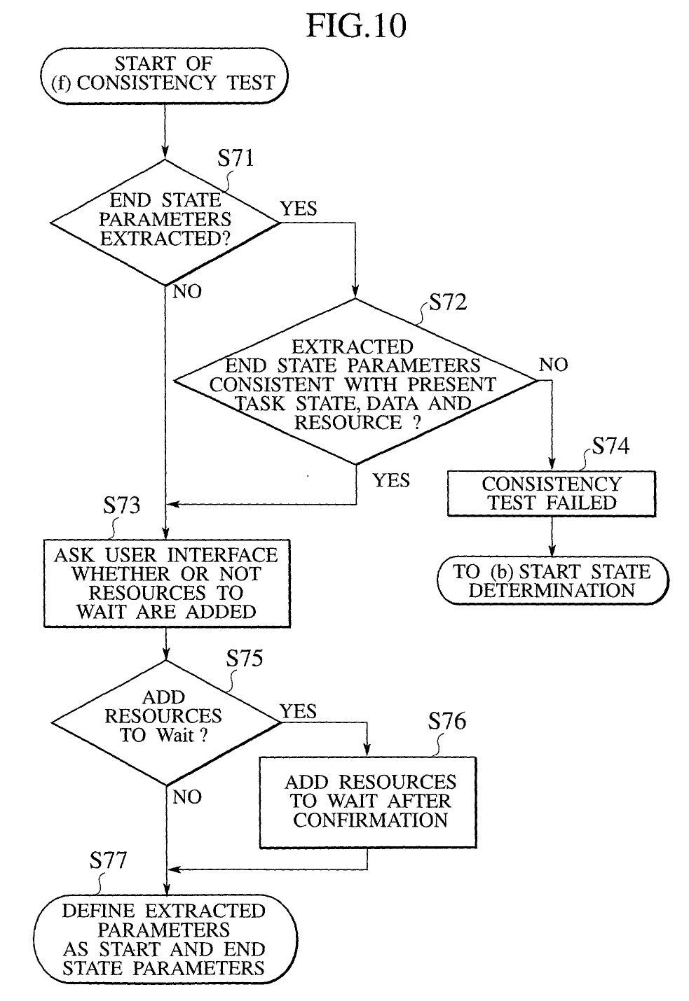

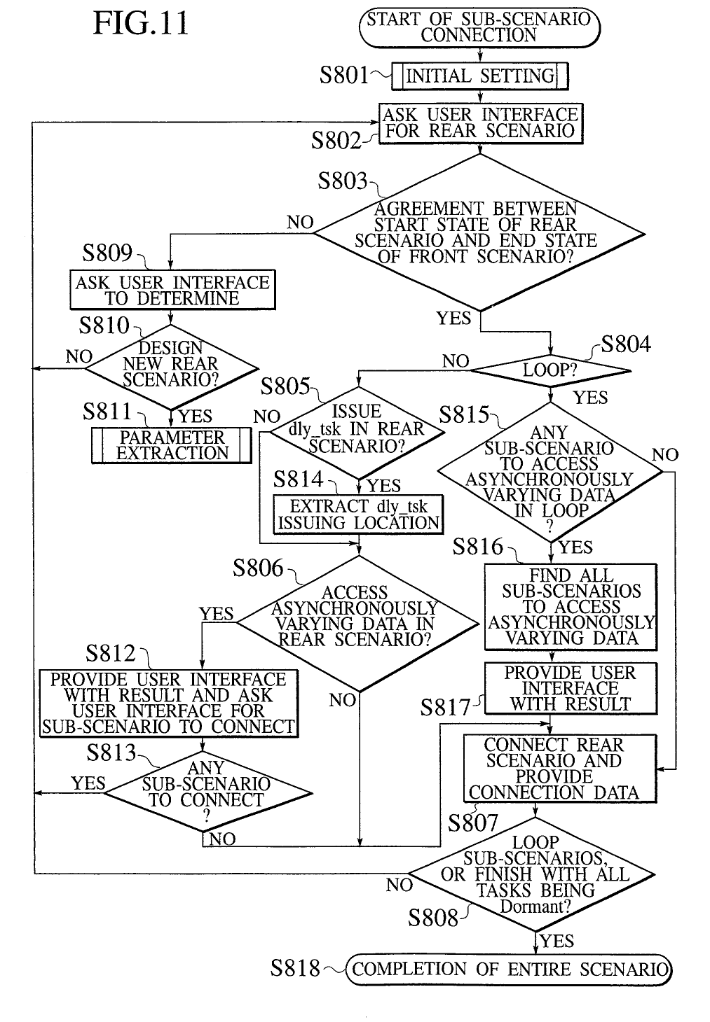

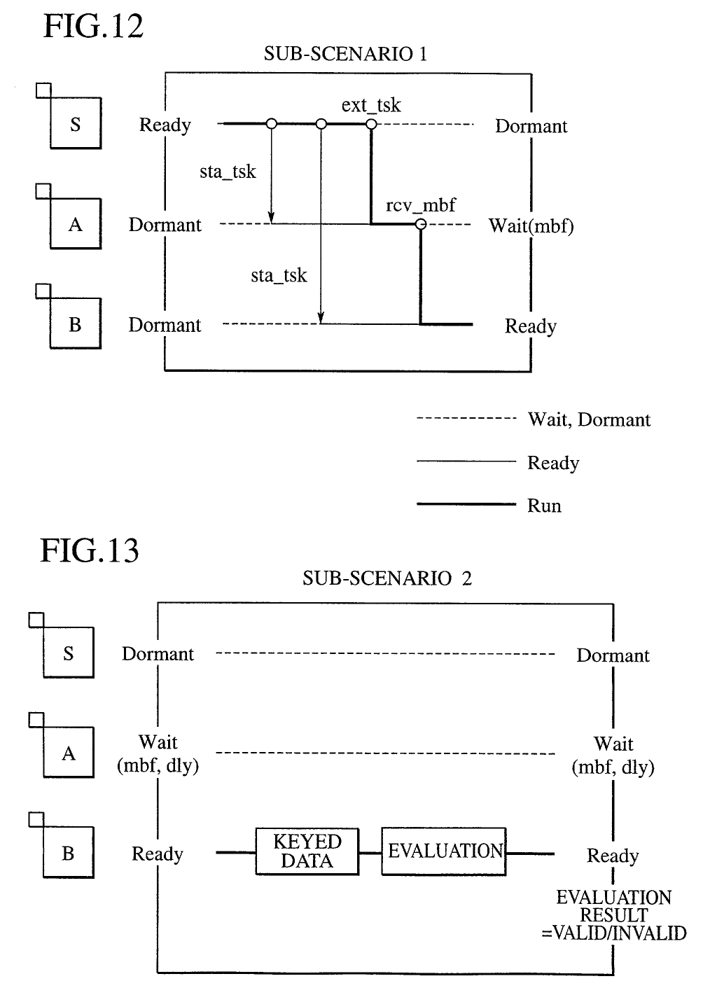

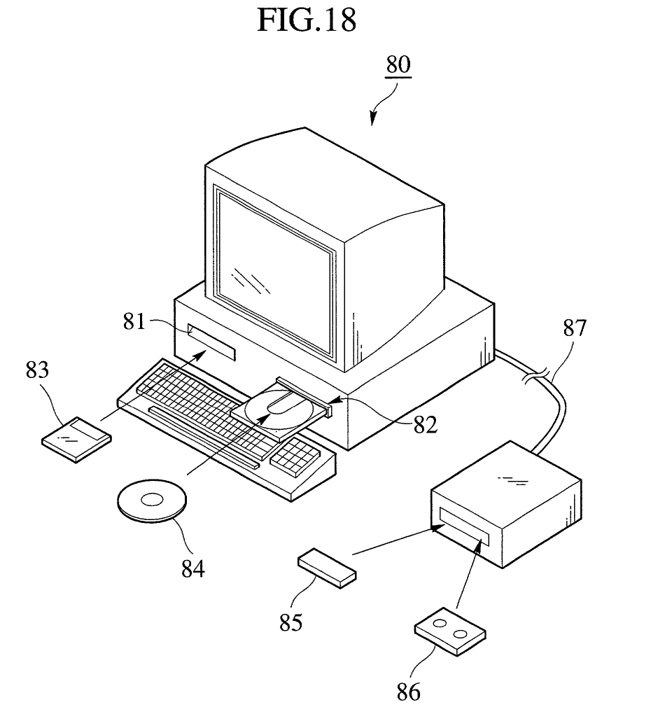

FIG. 5 is a flowchart showing the operation of the parameter extractor 12 of FIG. 4, FIG. 6 is a flowchart showing “(b) Initial state determination” of FIG. 5, FIG. 7 is a flowchart showing “(c) Operation registration” of FIG. 5, FIG. 8 is a flowchart showing “(d) Data extraction” of FIG. 5, FIG. 9 is a flowchart showing “(e) State extraction” of FIG. 5, FIG. 10 is a flowchart showing “(f) Consistency test” of FIG. 5, FIG. 11 is a flowchart showing the operation of the connector-tester 13 of FIG. 4, FIGS. 12 to 16 show sub-scenarios 1 to 5, and FIG. 17 shows a concept of sub-scenario connection.

Defining the sub-scenario 1 of FIG. 12 will be explained. The sub-scenario 1 describes the task S activating the tasks A and B.

In step S20 “(a) Initial setting” of FIG. 5, the user interface 11 receives data entered by the user.

In step S30 “(b) Initial state determination” of FIG. 5, the parameter extractor 12 receives data from the user interface 11 and extracts start state parameters from the received data. The extracted parameters indicate that the task S is ready, the tasks A and B are dormant, and a resource to access is a message buffer (mbf). The extracted data is sent to the user interface 11, and at the same time, is stored in the state memory 14.

Step S40 “(c) Operation registration” of FIG. 5 asks the user interface 11 for the next operation of the task S. The user interface 11 shows the user all task states and waits for the user registering an operation of the task S. To define the sub-scenario 1, the user registers the issuance of the system call “sta_tsk” for the task A, the system call “sta_tsk” for the task B, and the system call “ext_tsk.” The details of registration of these system calls will be explained.

<Registering “sta_tsk(Task A)” Issuance in Task S>

Referring to “(c) Operation registration” of FIG. 7, step S41 checks to see if there is at least one ready task. The task S is ready, and therefore, step S41 is YES.

Step S42 finds the task S as a task having the highest priority among tasks that are ready.

Step S43 asks the user interface 11 for task operation defining data. The user enters “sta_tsk(task A)” as an operation for the task S into the user interface 11.

The flow advances to “(d) Data extraction” of FIG. 8.

The registered task operation “sta_tsk” accesses no resource or data, and therefore, step S51 is NO.

The flow advances to “(e) State extraction” of FIG. 9.

The registered task operation “sta_tsk” is not “wai_sem,” etc., and therefore, step S610 is NO.

The registered task operation is “sta_tsk,” and therefore, step S620 is YES.

There is no task having higher priority than the task S, and therefore, step S621 is NO. Step S640 asks the user interface 11 whether or not the sub-scenario definition must be finished.

The sub-scenario definition is not finished, and therefore, step S641 is NO.

The flow returns to “(c) Operation registration” of FIG. 7.

<Registering “sta_tsk(Task B)” Issuance in Task S>

Step S41 of FIG. 7 checks to see if there is at least one ready task. The tasks S and A are ready at this moment, and therefore, step S41 is YES.

Step S42 detects the task S as a task having the highest priority among the ready tasks.

Step S43 asks the user interface 11 for task operation defining data for the task S. The user enters “sta_tsk(task B)” as an operation for the task S into the user interface 11.

The flow advances to “(d) Data extraction” of FIG. 8.

The registered task operation “sta_tsk” accesses no resource or data, and therefore, step S51 is NO.

The flow advances to “(e) State extraction” of FIG. 9.

The registered task operation “sta_tsk” is not “wai_sem,” etc., and therefore, step S610 is NO.

The registered task operation is “sta_tsk,” and therefore, step S620 is YES.

There is no task having higher priority than the task S, and therefore, step S621 is NO. Step S640 asks the user interface 11 whether or not the sub-scenario definition must be finished.

The sub-scenario definition is not finished, and therefore, step S641 is NO.

The flow returns to “(c) Operation registration” of FIG. 7.

<Registering “ext_tsk” Issuance in Task S>

Step S41 of FIG. 7 checks to see if there is at least one ready task. The tasks S, A, and B are ready at this moment, and therefore, step S41 is YES.

Step S42 detects the task S as a task having the highest priority among the ready tasks.

Step S43 asks the user interface 11 for task operation defining data. The user enters “ext_tsk” as an operation for the task S into the user interface 11.

The flow advances to “(d) Data extraction” of FIG. 8.

The registered task operation “ext_tsk” accesses no resource or data, and therefore, step S51 is NO.

The flow advances to “(e) State extraction” of FIG. 9.

Due to the registered task operation “ext_tsk,” step S610 is YES.

Due to the registered task operation “ext_tsk,” step S611 makes the task S dormant.

The tasks A and B are ready. Namely, there is a ready task having lower priority than the task S, and therefore, step S612 is YES. Step S640 asks the user interface 11 whether or not the sub-scenario definition must be finished.

The sub-scenario definition is not finished, and therefore, step S641 is NO.

The flow returns to “(c) Operation registration” of FIG. 7.

<Registering “rcv_mbf” Issuance in Task A>

Step S41 of FIG. 7 checks to see if there is at least one ready task. The tasks A and B are ready at this moment, and therefore, step S41 is YES.

Step S42 detects the task A as a task having the highest priority among the ready tasks.

Step S43 asks the user interface 11 for task operation defining data. The user enters “rcv_mbf” as an operation for the task A into the user interface 11.

The flow advances to “(d) Data extraction” of FIG. 8.

The registered task “rcv_mbf” accesses resources or data, and therefore, step S51 is YES.

Step S52 extracts the message buffer (mbf) as a resource to access.

The present scenario, i.e., the sub-scenario 1 has not issued “dly_tsk,” and therefore, step S53 is NO.

An access result causes no branching of the scenario, and therefore, step S55 is NO.

The sub-scenario definition is not finished, and therefore, step S58 is NO.

The flow advances to “(e) State extraction” of FIG. 9.

Due to the registered task operation “rcv_mbf,” step S610 of FIG. 9 is YES.

Due to the registered task operation “rcv_mbf,” step S611 puts the task A in wait state to wait for data from the message buffer.

The task B having lower priority than the task A is ready, and therefore, step S612 is YES. Step S640 asks the user interface 11 whether or not the sub-scenario definition must be finished.

The sub-scenario definition is finished, and therefore, step S641 is YES.

The flow advances to “(f) Consistency test” of FIG. 10.

End state parameters are not extracted, and therefore, step S71 of FIG. 10 is NO.

Step S73 asks the user interface 11 whether or not a resource to wait must be added to the tasks.

No wait resource is added to the tasks, and therefore, step S75 is NO.

Step S77 defines, as end state parameters of the sub-scenario 1, the extracted parameters including “dormant” for the task S, “wait(mbf)” for the task A, “ready” for the task B, and the message buffer serving as a resource to be accessed.

This completes the definition of the sub-scenario 1 of FIG. 12.

When a sub-scenario is partly amended or a new sub-scenario is inserted, there are already defined front and rear sub-scenarios to be connected to the amended or inserted sub-scenario. Namely, the start and end states of the amended or inserted sub-scenario are already defined. When step S71 of FIG. 10 is YES, it means that a rear scenario connected to the sub-scenario 1 is already defined.

<User Defining Process of Evaluating Keyed Data in Task B>

Defining a sub-scenario 2 of FIG. 13 will be explained. The sub-scenario 2 describes the task B 1) accepting keyed data from a telephone user and 2) evaluating if the keyed data is valid. The sub-scenario 2 involves conditional branching, and therefore, has two end states. In this regard, the sub-scenario 2 greatly differs from the sub-scenario 1.

The parameter extractor 12 of FIG. 4 carries out “(b) Initial state determination” of FIGS. 5 and 6.

The present scenario, i.e., the sub-scenario 2 is not at the start of the system, and therefore, step S32 of FIG. 6 is NO.

The sub-scenario 2 is irrelevant to a delay wakeup task, and therefore, step S33 is NO. The “delay wakeup task” is a ready state task which woke up from a wait state due to a time-out after an issuance of system call “dly_tsk”.

Step S34 extracts the end state of the front sub-scenario, i.e., the sub-scenario 1 as the start state of the sub-scenario 2 and outputs the start state to the user interface 11.

The end state of the sub-scenario 1 is not branching, and therefore, step S35 is NO.

There is no available resource for the resource waiting task, i.e., the task A at the start of the sub-scenario 2, and therefore, step S36 is NO.

A rear scenario, i.e., a sub-scenario 3 is not defined yet at this moment, and therefore, step S37 is NO.

The flow advances to “(c) Operation registration” of FIG. 7.

There is a ready task, i.e., the task B, and therefore, step S41 of FIG. 7 is YES.

Step S42 finds the task B as a task having the highest priority among tasks that are ready.

Step S43 asks the user interface 11 for operation defining data of the task B.

The flow advances to “(d) Data extraction” of FIG. 8.

The registered task operation “keyed data” accesses no resource or data, and therefore, step S51 is NO.

The flow advances to “(e) State extraction” of FIG. 9.

The registered task operation is not “wai_sem,” etc., and therefore, step S610 is NO.

The registered task operation is not “sig_sem,” etc., and therefore, step S620 is NO.

The registered task operation is not “dly_sk,” and therefore, step S630 is NO.

Step S640 asks the user interface 11 whether or not the sub-scenario definition must be finished.

The sub-scenario definition is not finished, and therefore, step S641 is NO.

The flow returns to “(c) Operation registration” of FIG. 7.

The task B is ready. Namely, there is at least one ready task, and therefore, step S41 of FIG. 7 is YES.

Step S42 detects the task B as a task having the highest priority among the ready tasks.

Step S43 asks the user interface 11 for task operation defining data of the task B.

The flow advances to “(d) Data extraction” of FIG. 8.

The registered task operation “evaluation” accesses resources or data, and therefore, step S51 is YES. Step S52 extracts a resource or data to access.

The present scenario, i.e., the sub-scenario 2 is not a delay wakeup task, and therefore, step S53 is NO.

The sub-scenario 2 is branched according to an access result, and therefore, step S55 is YES. Step S56 asks the user interface 11 for the number of branches. Step S57 extracts the number of branches and parameters to determine branch targets. According the embodiment, the user enters that there are two branches, i.e., a keyed data valid branch and a keyed data invalid branch and that an evaluation parameter is an evaluation result.

The flow advances to “(f) Consistency test” of FIG. 10.

End state parameters are not extracted, and therefore, step S71 of FIG. 10 is NO.

Step S73 asks the user interface 11 whether or not a resource to wait must be added to the tasks.

If a wait resource is added to the tasks, step S75 is YES. In this case, step S76 confirms that the resource to be added is not accessed in the sub-scenario 2 and adds the wait resource.

The task A has no defined operation, and therefore, a wait object may be added to the “wait(mbf)” state of the task A. Accordingly, the user adds wait state based on “dly_tsk” as a start state parameter and end state parameter to the task A.

This completes the definition of the sub-scenario 2 of FIG. 13.

<User Defining Process of Accessing OS Resource in Task B>

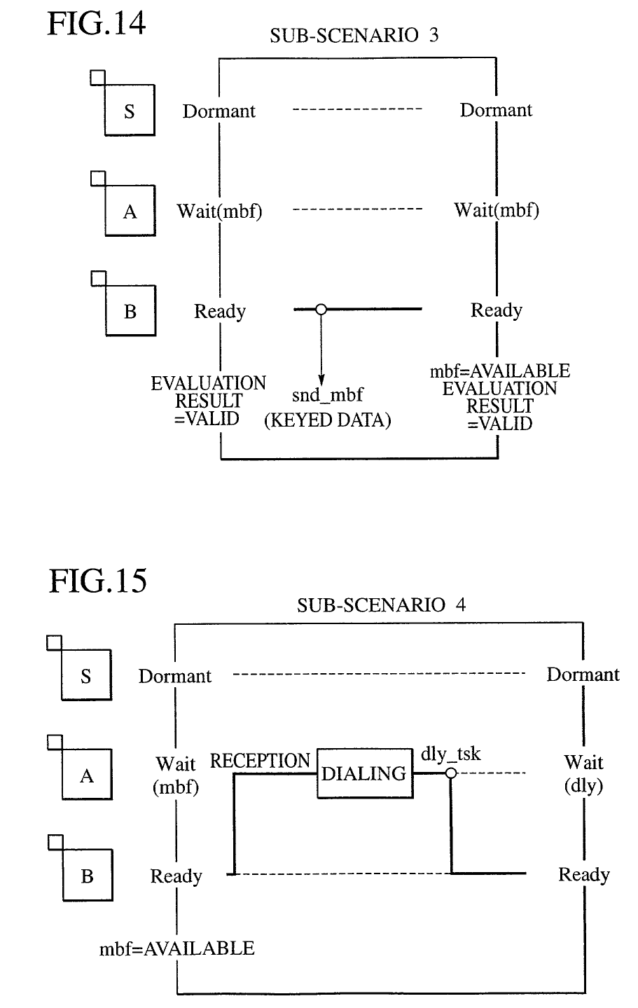

Defining a sub-scenario 3 of FIG. 14 will be explained. The sub-scenario 3 describes the task B accessing an OS resource to transmit an evaluation result.

If the keyed data evaluation carried out by the front sub-scenario 2 is “valid,” the task B issues “snd_mbf” to transmit the keyed data to the task A that is waiting for receiving data from the message buffer.

If the keyed data evaluation carried out by the sub-scenario 2 is “invalid,” the task B carries out a loop operation until valid keyed data is received. Due to this, the end of the sub-scenario 2 is coupled to the start of the sub-scenario 2. This coupling will be explained later.

When defining the sub-scenario 3, “(b) Initial state determination” of FIG. 6 carried out by the parameter extractor 12 determines that the end state of the front scenario 2 involves branching. Namely, step S35 of FIG. 6 is YES. Step S38 extracts a branching evaluation factor “evaluation result” and a branching content “valid” and employs them as start state parameters in addition to other task states.

Like the definition of the sub-scenario 1, the user enters an operation of the task B of issuing “snd_mbf.” The registered task operation accesses a resource or data, and therefore, step S51 of “(d) Data extraction” of FIG. 8 is YES.

The present scenario, i.e., the sub-scenario 3 has not issued “dly_tsk,” and therefore, step S53 is NO.

The sub-scenario 3 involves no branching according to a result of accessing the message buffer, and therefore, step S55 is NO.

The operation of the task A after receiving data from the message buffer is used to start a loop, and therefore, the user selects YES in step S58 to finish the sub-scenario definition. If the sub-scenario definition is not finished and if an operation for the task A is defined continuously, the sub-scenario may be divided later, if required.

<User Defining Asynchronous Process (Time-out Process in this Embodiment) in Task A>

Defining a sub-scenario 4 of FIG. 15 will be explained. The sub-scenario 4 describes the task A carrying out dialing and a time-out process to accept keyed data from the telephone user during the dialing.

“(b) Initial state determination” of FIG. 6 is carried out at first.

The present scenario, i.e., the sub-scenario 4 is not at the system start, and therefore, step S32 is NO. The sub-scenario 4 is not a delay wakeup task, and therefore, step S33 is NO.

Step S34 extracts the end state of the front sub-scenario, i.e., the sub-scenario 3 as the start state of the sub-scenario 4. Namely, the start state of the sub-scenario 4 includes the task S being dormant, the task A being wait(mbf), and the task B being ready.

The end state of the sub-scenario 3 involves branching, and therefore, step S35 is YES.

Step S38 extracts the data, resources, and the contents thereof used for evaluating branching conditions. Namely, step S38 extracts “mbf=available” and “evaluation result =valid.”

For the resource waiting task A, the resource “mbf” is ready to send data at the start of the sub-scenario 4, and therefore, step S36 is YES.

Step S39 updates the resource waiting task A to ready state and the resource “mbf” to a transmitted state.

A rear scenario, i.e., a sub-scenario 5 is not defined yet at this moment, and therefore, step S37 is NO. The flow advances to “(c) Operation registration” of FIG. 7.

Like the definition of the sub-scenario 1, the user enters, for the task A, a process of dialing based on the received message and a process of issuing the system call “dly_tsk” to wait for a predetermined period to finish the dialing.

After “(c) Operation registration” of FIG. 7, the flow advances to “(d) Data extraction” of FIG. 8.

The registered task operation “dly_tsk” accesses no resource or data, and therefore, step S51 is NO. The flow advances to “(e) State extraction” of FIG. 9.

In FIG. 9, the registered task operation is “dly_tsk,” and therefore, step S630 is YES. Step S631 updates the state of the task A to “wait(dly_tsk).” The flow advances to “(f) Consistency test” of FIG. 10.

<User Defining Resources or Data to be Accessed in Asynchronous Process>

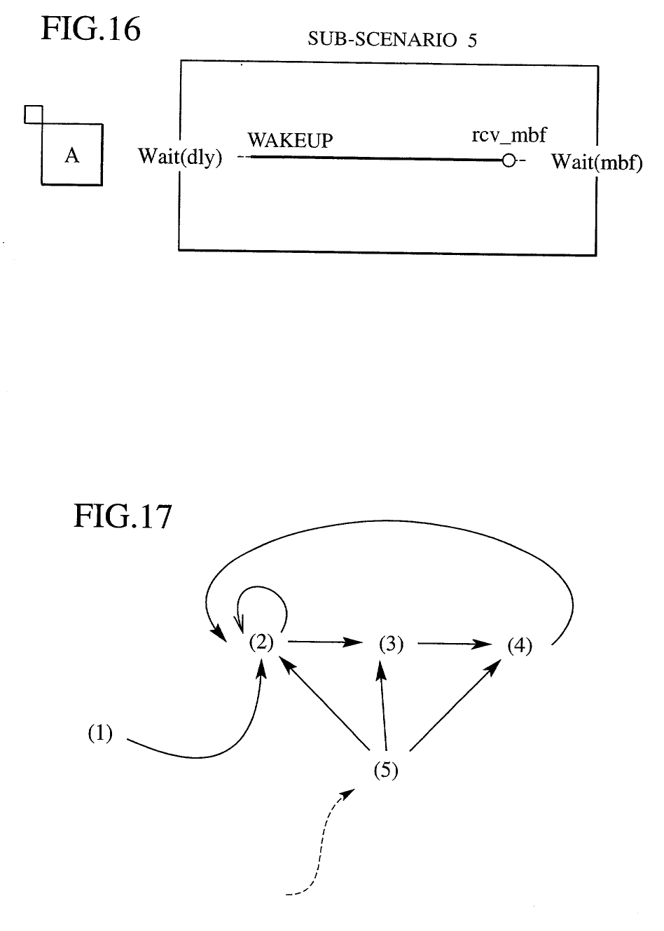

Defining a sub-scenario 5 of FIG. 16 will be explained. The sub-scenario 5 describes the task A accessing an OS resource after the time-out of the wait state “dly_tsk.”

The present scenario, i.e., the sub-scenario 5 is a delay wakeup task, and therefore, step S33 of FIG. 6 is YES. Accordingly, the delay wakeup task, i.e., the task A is extracted as “ready” and the other tasks as “don't care.” These states are extracted as the start state of the sub-scenario 5.

The flow advances to “(c) Operation registration” of FIG. 7.

Like the definition of the sub-scenario 1, the user registers an operation for the task A. The operation to register is that the task A issues “rcv_mbf” to wait for dial data from the message buffer. The task A is an asynchronous wakeup task, and therefore, the operation must be defined so that the task A can cope with any change in the message buffer under any system state.

To secure this, step S54 of “(d) Data extraction” of FIG. 8 extracts the message buffer and writes it as asynchronously varying data into the state memory 14.

In “(e) State extraction” of FIG. 9, step S612 is NO to indicate that there is no ready task of lower priority. This completes the definition of the sub-scenario 5, and the flow goes to “(f) Consistency test” of FIG. 10.

Thus, the definition of the sub-scenarios 1 to 5 is complete.

[Connecting Sub-scenarios and Forming Real-Time System]

FIG. 11 is a flowchart showing the operation of connecting sub-scenarios, and FIG. 17 roughly shows a real-time system formed by connecting the sub-scenarios 1 to 5. Connecting sub-scenarios according to the flow of FIG. 11 forms a real-time system that consistently operates. This flow is executed by the consistency tester 13 of FIG. 4. In FIG. 17, parenthesized numbers (1) to (5) represent the sub-scenarios 1 to 5. The sub-scenario 5 is asynchronous, and therefore, a dotted line is connected thereto.

When connecting the sub-scenario 2 to the sub-scenario 1, the consistency tester 13 1) reads all task start states (with data and resources, if any) of the rear scenario, i.e., the sub-scenario 2 and all task end states (with data and resources, if any) of the front scenario, i.e., the sub-scenario 1, 2) compares corresponding state parameters with one another, and 3) determines whether or not the start state parameters of the rear scenario agree with the end state parameters of the front scenario. This is done in step S803 of FIG. 11. In this embodiment, all parameters agree with one another, and therefore, step S803 is YES.

Steps S804 to S807 test the definitions of the rear sub-scenario 2. Namely, step S804 checks to see if a loop is formed and provides NO. Step S805 checks to see if the rear scenario involves “dly_tsk” and provides NO. Step S806 checks to see if the rear scenario accesses asynchronously varying data and provides NO. Step S807 completes the connection between the sub-scenarios 1 and 2 and provides the related connection data.

These processes follow steps S801, S802, S803, S804, S805, S806, S807, and S808 of FIG. 11.

The sub-scenario 2 involves two end states, and therefore, the user must select, in step S802 of FIG. 11, two sub-scenarios to be connected to the sub-scenario 2 according to the two end states.

If the end state of the sub-scenario 2 is “evaluation result=invalid,” the task B must be looped to wait for keyed data. To realize this, the user connects the end of the sub-scenario 2 to the start thereof. Comparing the start and end states of the sub-scenario 2 with each other, it is understood that the end state “evaluation result” is not present at the start of the sub-scenario 2. In this case, parameters that are present at the start of the sub-scenario 2 are compared with corresponding end state parameters of the front sub-scenario, to establish connection. In this embodiment, only the task states are compared with one another to see if they agree with one another.

These processes follow steps S801, S802, S803, S804, S815, S807, and S808 of FIG. 11.

If the end state of the sub-scenario 2 is “evaluation result=valid,” the sub-scenario 3 is connected to the sub-scenario 2, and the evaluation result is transferred to the message buffer. Connecting the sub-scenarios 2 and 3 is carried out like connecting the sub-scenarios 1 and 2. These processes follow steps S801, S802, S803, S804, S805, S806, S807, and S808 of FIG. 11.

Connection of the sub-scenarios 3 and 4 is similarly carried out. In the subscenario 4, the task A issues the system call “dly_tsk.” Namely, step S805 is YES to indicate that the rear scenario involves the issuance of “dly_tsk.” Step S814 extracts a “dly_tsk” issuing location.

The parameter extractor 12 of FIG. 4 has extracted the message buffer as asynchronous data, and the sub-scenario 4 involves a reception process of data from the message buffer. Accordingly, step S806 is YES to indicate that the rear scenario accesses asynchronously varying data, and step S812 transfers this determination to the user interface 11. It is determined that no asynchronous change occurs in the message buffer at this moment, and therefore, step S813 is YES to indicate that the sub-scenario 4 is connectable.

These processes follow steps S801, S802, S803, S804, S805, S814, S806, S812, and S813 of FIG. 11.

Connection of the sub-scenario 4 to the sub-scenario 2 will be explained. To wait for the next keyed data after dialing, the user connects the end of the sub-scenario 4 to the start of the sub-scenario 2. This connection is achieved like the connection of the sub-scenarios 1 and 2. In FIG. 11, step S804 is YES to indicate that a loop is formed. The sub-scenario 3 contained in the loop accesses asynchronously varying data, i.e., the message buffer, step S815 is YES to indicate that the loop contains a sub-scenario that accesses asynchronously varying data. Step S817 informs the user, through the user interface 11, that the task A may affect the task B in the sub-scenario 3. Step S807 connects the sub-scenario 4 to the sub-scenario 2 and provides the connection data.

These processes follow steps S801, S802, S803, S804, S815, S816, S817, S807, S808, and S818 of FIG. 11.

The sub-scenario 5 starts from a wakeup due to time-out of the wait state “dly_tsk.” Accordingly, it is impossible to determine a sub-scenario to be connected in front of the sub-scenario 5, and therefore, only a rear sub-scenario is connected to the sub-scenario 5. Step S802 asks the user interface 11 for rear scenarios, selects sub-scenarios to be executed after the issuance of “dly_tsk” according to all read scenario parameters, and displays the selected sub-scenarios for the user. In this embodiment, the subscenarios to be executed after the issuance of “dly_tsk” are the sub-scenarios 2, 3, and 4. It is determined that all of the sub-scenarios 2, 3, and 4 have start states agreeing with the end state of the sub-scenario 5, and therefore, that each of them is connectable to the end of the sub-scenario 5. The sub-scenarios 2, 3, and 4 are presented to the user through the user interface 11.

In this way, the connection of the sub-scenarios shown in FIG. 17 is completed to finish the real-time system.

According to the present invention, each sub-scenario causes no branching due to asynchronous interrupts. The present invention checks the end states and start states of sub-scenarios before connecting the sub-scenarios to one another, to cause no inconsistency when the sub-scenarios are connected together to form a real-time system.

The steps of the real-time system designing method of the present invention may be described as a computer program and stored in a storage medium. The program in the storage medium is read and executed by a computer to carry out the real-time system designing steps. The storage medium may be any medium capable of storing computer programs, such as a memory, a magnetic disk, an optical disk, and a magnetic tape.

FIG. 18 roughly shows an example of a computer system that is capable of reading the real-time system designing program of the present invention from a storage medium and executing the program. The computer system 80 has a floppy disk drive 81 and a CD-ROM drive 82. A magnetic floppy disk 83 and an optical CD-ROM 84 store programs including the real-time system designing program of the present invention and are inserted into the drives 81 and 82, respectively. The programs in the floppy disk 83 and CD-ROM 84 are read by and installed in the computer system 80. A drive for handling a ROM 85 (for example, a game pack) and a magnetic cassette tape 86 may be connected to the computer system 80, the ROM 85 and cassette tape 86 being used to store programs such as the real-time system designing program of the present invention.

In summary, the present invention is capable of designing a real-time system capable of consistently executing a plurality of operations in parallel and controlling synchronous communication among the operations. The present invention is also capable of shortening the development period of applications to be designed based on the real-time system.

Various modifications will become possible for those skilled in the art after receiving the teachings of the present disclosure without departing from the scope thereof.

What is claimed is:

1. An apparatus for designing a real-time system involving a plurality of tasks, the apparatus comprising:
an asynchronous factor tester testing whether or not task operations arranged in time series in each section of the real-time system are affected by asynchronously occurring factors.

2. The apparatus of claim 1, wherein the asynchronous factor tester comprises:
a parameter extractor extracting the asynchronously occurring factor of each section of the real-time system; and
a branch tester testing whether or not the asynchronously occurring factor occurs branching of the each section.

3. The apparatus of claim 1, wherein the asynchronously occurring factor includes interrupt and time-out process.

4. An apparatus for designing a real-time system involving a plurality of tasks, the apparatus comprising:
a connector connecting sections each containing a series of tasks that are not affected by asynchronously occurring factors, to one another to form the real-time system; and
a tester testing if the connected sections operate consistently.

5. The apparatus of claim 4, wherein the tester comprises:
a reader reading a task start state of the rear section of the real-time system and a task end state of the front section of the real-time system;
a comparator comparing the task start state of the rear section with corresponding the task end state of the front section; and
a determination device determining whether or not the task start state of the rear section agree with the task end state of the front section.

6. The apparatus of claim 5, wherein the task state includes Dormant, Wait, Ready and Run.

7. A method for designing a real-time system involving a plurality of tasks, the method comprising:
testing whether or not task operations arranged in time series in each section of the real-time system are affected by asynchronously occurring factors.

8. The method of claim 7, wherein the testing operation comprises:
extracting the asynchronously occurring factor of each section of the real-time system, and testing whether or not the asynchronously occurring factor occurs branching of the each section.

9. The method of claim 7, wherein the asynchronously occurring factor includes interrupt and time-out process.

10. A method for designing a real-time system involving a plurality of tasks, the method comprising:
connecting sections each containing a series of tasks that are not affected by asynchronously occurring factors, to one another to form the real-time system; and
testing if the connected sections operate consistently.

11. The method of claim 10, wherein the testing operation comprises:
reading a task start state of the rear section of the real-time system and a task end state of the front section of the real-time system;
comparing the task start state of the rear section with corresponding the task end state of the front section; and
determining whether or not the task start state of the rear section agree with the task end state of the front section.

12. The method of claim 11, wherein the task state includes Dormant, Wait, Ready and Run.

13. A computer program product for designing a real-time system involving a plurality of tasks, the computer program product comprising:
testing whether or not task operations arranged in time series in each section of the real-time system are affected by asynchronously occurring factors.

14. The computer program product of claim 13, wherein the testing operation comprises:
extracting the asynchronously occurring factor of each section of the real-time system; and
testing whether or not the asynchronously occurring factor occurs branching of the each section.

15. The computer program product of claim 13, wherein the asynchronously occurring factor includes interrupt and time-out process.

16. A computer program product for designing a real-time system involving a plurality of tasks, the computer program product comprising:
connecting sections each containing a series of tasks that are not affected by asynchronously occurring factors, to one another to form the real-time system; and
testing if the connected sections operate consistently.

17. The program of claim 16, wherein the testing operation comprises:
reading a task start state of the rear section of the real-time system and a task end state of the front section of the real-time system;
comparing the task start state of the rear section with corresponding the task end state of the front section; and
determining whether or not the task start state of the rear section agree with the task end state of the front section.

18. The program of claim 17, wherein the task state includes Dormant, Wait, Ready and Run.
